(19) United States
(12) Patent Application Publication
(10) Pub. No.: US 2026/0155554 A1
(43) Pub. Date: Jun. 4, 2026

(54) TRANSFORMER WITH INTEGRATED DIFFERENTIAL POWER DIVIDER/COMBINER

(71) Applicant: NXP B.V., Eindhoven (NL)

(72) Inventors: Mark Pieter van der Heijden, Eindhoven (NL); Leo Lucas Lancon, Pessac (FR); Xin Yang, Eindhoven (NL); Sebastien Pruvost, Crolles (FR)

(21) Appl. No.: 19/363,457

(22) Filed: Oct. 20, 2025

(30) Foreign Application Priority Data
Oct. 23, 2024 (EP) 24306785.7

(51) Int. Cl. H01P 5/16; H01F 27/29

(52) U.S. Cl. CPC H01P 5/16; H01F 27/29

(57) ABSTRACT

Substantially equal mutual inductances between a primary coil and respective secondary windings of a secondary coil of a transformer with an integrated differential Wilkinson power divider or combiner help to ensure balanced outputs for the transformer. The primary coil and the secondary coil are substantially symmetric to provide a high coupling between the coils, and the secondary windings of the secondary coil are substantially symmetric to help provide the substantially equal mutual inductances. The secondary windings of the secondary coil cross over each other an equal number of times to further ensure balanced outputs for the transformer.

### CROSS-REFERENCE TO RELATED APPLICATIONS

This application claims priority under 35 U.S.C. § 119 to European patent application no. 24306785.7, filed Oct. 23, 2024 the contents of which are incorporated by reference herein.

### BACKGROUND

The present disclosure relates generally to a Wilkinson coupler, which can function as a power splitter or power combiner in, but not limited to, a radio frequency (RF) implementation. In the field of RF and microwave engineering, the Wilkinson power divider is a specific class of power divider circuit that can achieve isolation between output ports while maintaining a matched condition on all ports such that the impedance of the source and the load are substantially equal to maximize power transfer and minimize reflections at a desired operating frequency range. A conventional Wilkinson power divider splits an input signal into two equal phase output signals or combines two equal-phase signals into one signal. Thus, Wilkinson power dividers are typically reversible and often referred to as either a Wilkinson power splitter or combiner depending on how they are utilized in a circuit.

Conventional Wilkinson power dividers are easily implemented using printed components on a printed circuit board utilizing quarter wave (λ/4) transmission lines (TLs) to implement the required power combination or power split at a specific frequency. Typical designs use quarter wavelength transformers to split an input signal and to provide two output signals that are in phase. At lower frequencies, this implementation can be bulky in size due to required dimensions of the λ/4 TLs. Accordingly, such an implementation of the Wilkinson power divider tends to be used more often at higher, e.g., microwave, frequencies where the λ/4 transmission line lengths are not prohibitively large. Other designs use “lumped” element configurations that utilize, e.g., discrete circuit elements. “Lumped” element designs use discrete components such as resistors, capacitors, and inductors, which are treated as individual, concentrated circuit elements. In contrast with distributed elements based on TL theory that spread a circuit's reactive components over a length of TL, lumped elements are considered to have all their properties (resistance, capacitance, or inductance) concentrated at a single point or in discrete components. However, the use of lumped element components also makes accurate amplitude and phase matching of output ports more difficult due to different component tolerances.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a circuit diagram of a transformer with an integrated two-way differential power divider in accordance with some embodiments.

FIG. 2 is a perspective view showing a first layer of a transformer with an integrated two-way differential power divider in accordance with some embodiments.

FIG. 3 is a perspective view showing a second layer of a transformer with an integrated two-way differential power divider in accordance with some embodiments.

FIG. 4 is a perspective view showing a third layer of a transformer with an integrated two-way differential power divider in accordance with some embodiments.

FIG. 5 is a circuit diagram of a transformer with an integrated three-way differential power divider using star-connected isolation networks in accordance with some embodiments.

FIG. 6 is a perspective view showing a first layer of a transformer with an integrated three-way differential power divider in accordance with some embodiments.

FIG. 7 is a perspective view showing a second layer of a transformer with an integrated three-way differential power divider in accordance with some embodiments.

FIG. 8 is a perspective view showing a third layer of a transformer with an integrated three-way differential power divider in accordance with some embodiments.

FIG. 9 is a circuit diagram of a transformer with an integrated four-way differential power divider using star-connected isolation networks in accordance with some embodiments.

FIG. 10 is a perspective view showing first and second layers of a transformer with an integrated four-way differential power divider in accordance with some embodiments.

FIG. 11 is a perspective view showing a third layer of a transformer with an integrated four-way differential power divider in accordance with some embodiments.

FIG. 12 is a flow diagram of a method of assembling a transformer with an integrated differential power divider in accordance with some embodiments.

FIG. 13 is a flow diagram of a method of arranging traces in a transformer with an integrated differential power divider in accordance with some embodiments.

### SUMMARY OF EMBODIMENTS

In a first example embodiment, a differential Wilkinson power divider includes a primary coil between a positive input terminal and a negative input terminal; a first secondary winding between a first positive output terminal and a first negative output terminal; and a second secondary winding between a second positive output terminal and a second negative output terminal, where the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance. In some embodiments, the power divider further includes a first isolation network connected between the first positive output terminal and the second positive output terminal. In some embodiments, the first isolation network includes a capacitor in parallel with a resistor. In some embodiments, the power divider further includes a second isolation network connected between the first negative output terminal and the second negative output terminal. In some embodiments, the second isolation network includes a capacitor in parallel with a resistor. In some embodiments, the power divider further includes a third positive output terminal and a third negative output terminal corresponding to the third positive output terminal; and a third secondary winding between the third positive output terminal and the third negative output terminal, where the third secondary winding and the primary coil have a third mutual inductance, and the coefficient of coupling of the first mutual inductance is substantially equal to a coefficient of coupling of the third mutual inductance. In some embodiments, the power divider further includes an isolation network connected between the first positive output terminal and the third positive output terminal. In some embodiments, the isolation network includes a capacitor in parallel with a resistor. In some embodiments, the power divider further includes a fourth positive output terminal and a fourth negative output terminal corresponding to the fourth positive output terminal; and a fourth secondary winding between the fourth positive output terminal and the fourth negative output terminal, where the fourth secondary winding and the primary coil have a fourth mutual inductance, and the coefficient of coupling of the first mutual inductance is substantially equal to a coefficient of coupling of the fourth mutual inductance. In some embodiments, the power divider further includes an isolation network connected between the first positive output terminal and the fourth positive output terminal.

In a second example embodiment, a differential Wilkinson power divider includes a primary coil comprising a first positive input terminal and a first negative input terminal; and a secondary coil comprising a first secondary winding and a second secondary winding, the first secondary winding including a first positive output terminal and a first negative output terminal, and the second secondary winding including a second positive output terminal and a second negative output terminal, where the primary coil and the secondary coil are substantially symmetric, and the first secondary winding and the second secondary winding of the secondary coil are substantially symmetric. In some embodiments, a shape of the first secondary winding of the secondary coil is substantially identical to a mirrored shape of the second secondary winding of the secondary coil. In some embodiments, the first secondary winding of the secondary coil crosses the second secondary winding of the secondary coil. In some embodiments, the secondary coil further comprises a third secondary winding including a third positive output terminal and a third negative output terminal, and where the first secondary winding of the secondary coil crosses the second secondary winding and the third secondary winding an equal number of times. In some embodiments, the secondary coil further comprises a fourth secondary winding including a fourth positive output terminal and a fourth negative output terminal, and where the first secondary winding of the secondary coil crosses the second secondary winding, the third secondary winding, and the fourth secondary winding an equal number of times. In some embodiments, the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance.

In a third example embodiment, a method of using a Wilkinson power divider includes connecting a primary coil between a positive input terminal and a negative input terminal; connecting a first secondary winding between a first positive output terminal and a first negative output terminal; and connecting a second secondary winding between a second positive output terminal and a second negative output terminal, where the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance. In some embodiments, the method further includes connecting a first isolation network between the first positive output terminal and the second positive output terminal. In some embodiments, the first isolation network includes a capacitor in parallel with a resistor. In some embodiments, the method further includes using the power divider as a power combiner by using the inputs as outputs and using the outputs as inputs. In some embodiments, the method further includes connecting a third secondary winding between a third positive output terminal and a third negative output terminal, where the third secondary winding and the primary coil have a third mutual inductance, and the coefficient of coupling of the first mutual inductance is substantially equal to a coefficient of coupling of the third mutual inductance.

In a fourth example embodiment, a differential Wilkinson power divider includes: a primary coil between a positive input terminal and a negative input terminal; and a secondary coil comprising a first secondary winding and a second secondary winding, the first secondary winding including a first positive output terminal and a first negative output terminal, and the second secondary winding including a second positive output terminal and a second negative output terminal, wherein the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance, and wherein the primary coil and the secondary coil are substantially symmetric, and the first secondary winding and the second secondary winding of the secondary coil are substantially symmetric. In some embodiments, the Wilkinson power divider includes a first isolation network connected between the first positive output terminal and the second positive output terminal. In some embodiments, a shape of the first secondary winding of the secondary coil is substantially identical to a mirrored shape of the second secondary winding of the secondary coil. In some embodiments, the first secondary winding of the secondary coil crosses the second secondary winding of the secondary coil.

### DETAILED DESCRIPTION

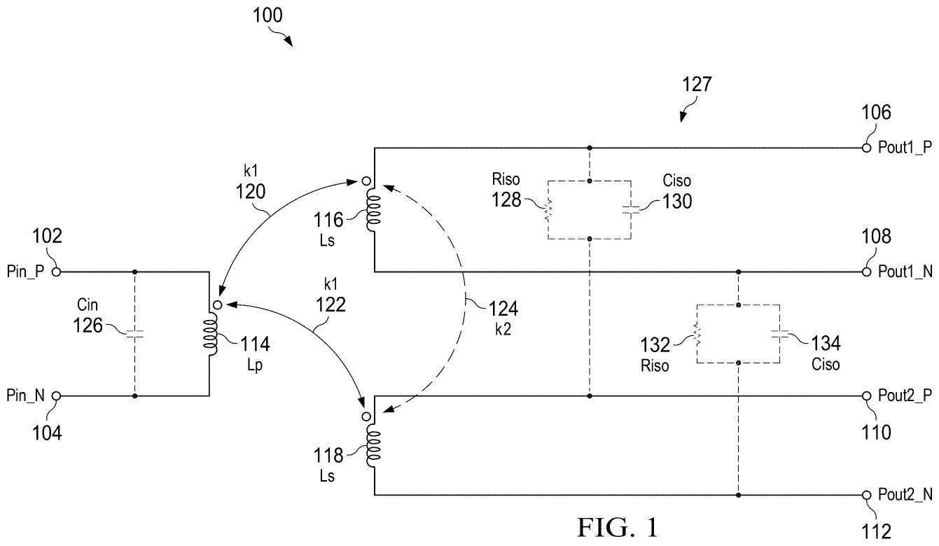

FIGS. 1-13 illustrate systems and techniques for implementing transformers with integrated 2-way, 3-way, or N-way (e.g., 4-or-more-way) Wilkinson power dividers with balanced outputs, e.g., equal amplitude outputs in-phase with one another, high performance characteristics, and compact form factors. In some embodiments, in order to ensure balanced outputs at output ports of a transformer, characteristics of the secondary windings of the transformer are configured substantially identically and the secondary windings are configured to be symmetric to each other. For example, in some embodiments, mutual inductances between a primary coil and each of the secondary windings of a secondary coil of a transformer are substantially equal and each of the secondary windings are configured to have similar or identical shapes. In some embodiments, each of the secondary windings are configured to cross each of the other secondary windings an equal number of times, helping to ensure balanced outputs for the transformer. Aspects of the present disclosure enable implementation of transformers with integrated N-way Wilkinson power dividers having a compact circuit layout and a minimal on-chip footprint.

FIG. 1 is a circuit diagram of a transformer 100 with an integrated two-way differential power divider in accordance with some embodiments, which functions substantially as a Wilkinson power divider, as, in some embodiments, it provides isolation between the output ports while maintaining a matched condition on all ports, e.g., such that the impedance at each port is equal to the impedance of each other port. As shown in FIG. 1, the transformer 100 with integrated two-way differential power divider includes a positive input terminal 102 and a negative input terminal 104, sometimes referred to as positive and negative input ports. Differential circuits are typically designed to reject common-mode noise that affects both input traces similarly, while differential Wilkinson splitters are designed to duplicate two input signals, such as the positive input terminal 102 and the negative input terminal 104 of the transformer 100 with integrated two-way differential power divider of FIG. 1, with minimal loss and high isolation between the outputs.

To provide the input signals as duplicated sets of output signals, the transformer 100 with integrated two-way differential power divider further includes a first positive output terminal 106 and a first negative output terminal 108 corresponding to the first positive output terminal 106, as well as a second positive output terminal 110 and a second negative output terminal 112 corresponding to the second positive output terminal 110, sometimes referred to as sets of positive and negative output ports. Notably, although the input and output terminals, e.g., the positive input terminal 102 and the positive output terminal 106, of the transformer 100 are described as input and output terminals, respectively, as discussed above, Wilkinson power dividers are typically reversible and often referred to as either a Wilkinson power splitter or combiner depending on how they are utilized in a circuit. Accordingly, in some embodiments where the transformer 100 with integrated two-way differential power divider is used as a power combiner rather than as a power splitter, the terminals of the transformer 100 with integrated two-way differential power divider referred to as “input” terminals, such as the positive input terminal 102, are instead used and function as outputs, while the terminals referred to as “output” terminals, such as the positive output terminal 106, are instead used and function as inputs.

To provide transformer functionality, the transformer 100 with integrated two-way differential power divider further includes a primary coil 114 between the positive input terminal 102 and the negative input terminal 104, a first secondary winding 116 between the first positive output terminal 106 and the first negative output terminal 108, and a second secondary winding 118 between the second positive output terminal 110 and the second negative output terminal 112. In order to ensure balanced outputs at the output ports of the transformer 100, in some embodiments, characteristics of the secondary windings are substantially identical. For example, in some embodiments, a first mutual inductance 120 between the primary coil 114 and the first secondary winding 116 is approximately or substantially equal to a second mutual inductance 122 between the primary coil 114 and the second secondary winding 118. However, a third mutual inductance 124 between the first secondary winding 116 and the second secondary winding 118 may be equal to or different from the first mutual inductance 120 and the second mutual inductance 122.

In some embodiments, an input capacitor 126 between the positive input terminal 102 and the negative input terminal 104 and in parallel with the primary coil 114 and variously provides for input electrostatic discharge protection, power factor correction, filtering, noise reduction, impedance matching, direct current blocking, and/or voltage regulation. In some embodiments, in order to provide isolation between the outputs, a first isolation network is connected between the first positive output terminal 106 and the second positive output terminal 110, and a second isolation network is connected between the first negative output terminal 108 and the second negative output terminal 112. As shown in FIG. 1, in some embodiments, the isolation networks 127 include a resistor and a capacitor. For example, the isolation network connected between the first positive output terminal 106 and the second positive output terminal 110 includes a first isolation resistor 128 in parallel with a first isolation capacitor 130. Similarly, the isolation network connected between the first negative output terminal 108 and the second negative output terminal 112 includes a second isolation resistor 132 in parallel with a second isolation capacitor 134. The specific, actual values for the resistors, capacitors, and mutual inductances of the transformer 100 with integrated two-way differential power divider will vary, and thus will need to be selected in accordance with specific implementations and tolerances.

In some embodiments, parasitic capacitances (not shown) between the positive input terminal 102 and the first positive output terminal 106, between the positive input terminal 102 and the second positive output terminal 110, between the first negative input terminal 104 and the first negative output terminal 108, and/or between the first negative input terminal 104 and the second negative output terminal 112 provide rejection at a specific frequency. In some embodiments, physical capacitors are added at these locations to increase and control the values of the capacitances between the respective terminals.

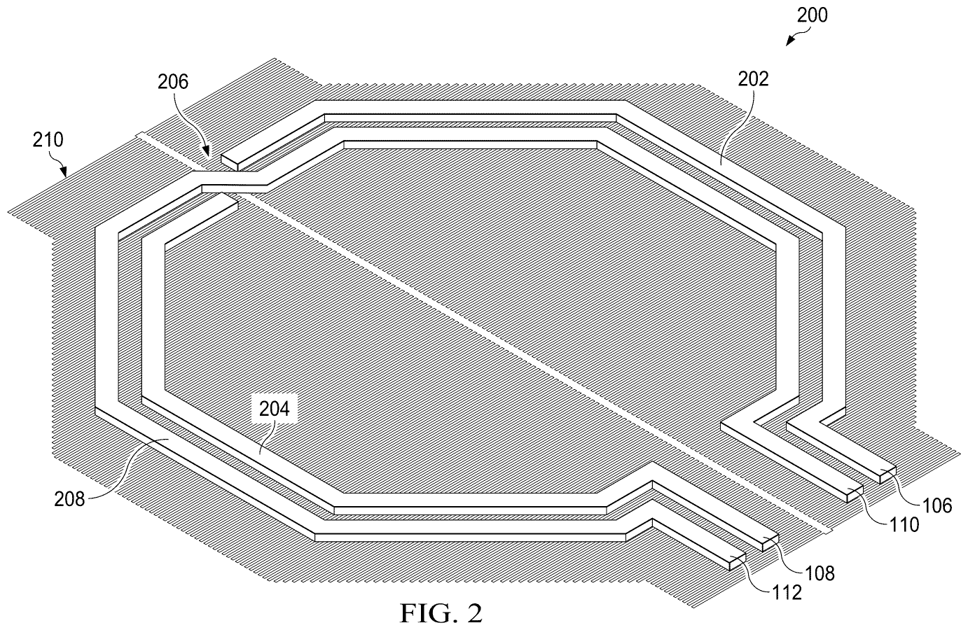

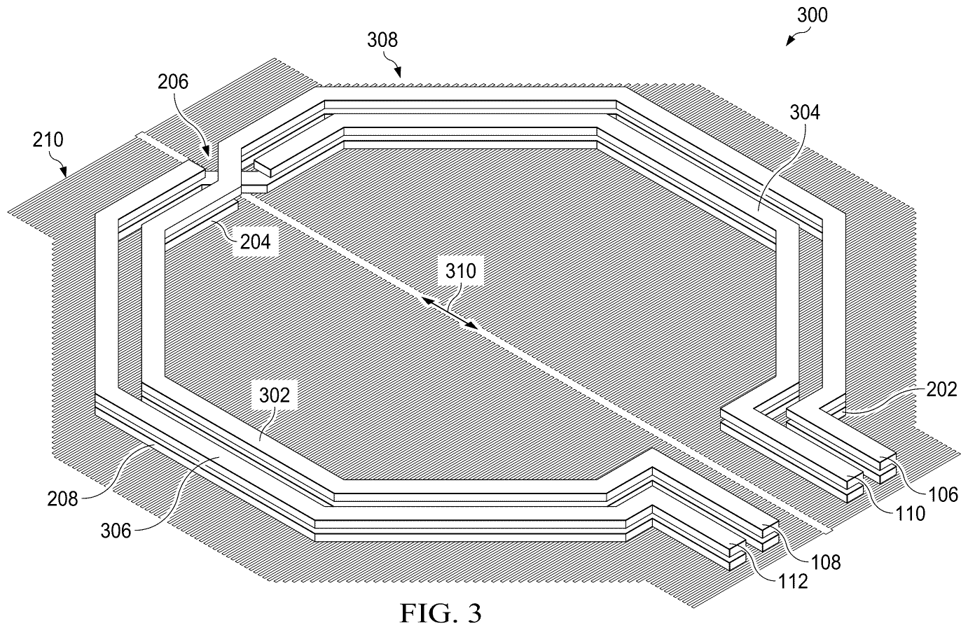

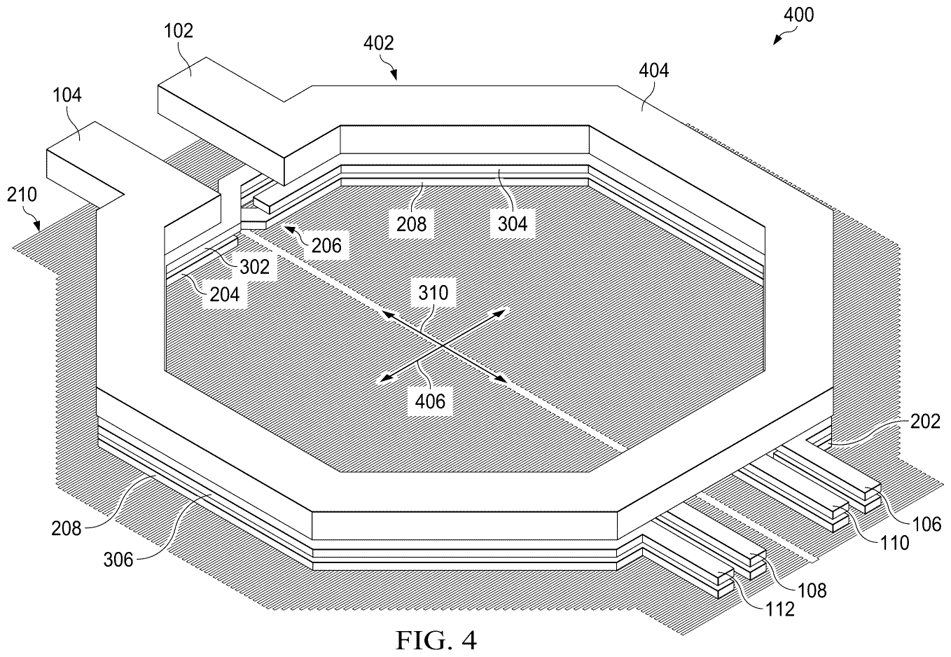

FIG. 2 is a perspective view showing a first layer 200 of a transformer with an integrated two-way differential power divider such as the transformer 100 with an integrated two-way differential power divider of FIG. 1 in accordance with some embodiments. As shown in FIG. 2, in some embodiments, the first positive output terminal 106 of a transformer with an integrated two-way differential power divider is connected to a first trace 202 and the first negative output terminal 108 is connected to a second trace 204. Notably, the first trace 202 and the second trace 204 are not directly connected at a crossover point 206 in the first layer 200. However, the second positive output terminal 110 and second negative output terminal 112 are connected to a single third trace 208, which is unbroken at the crossover point 206 in the first layer 200. Each of the first trace 202, the second trace 204, and the third trace 208 are deposited over an electromagnetic shield 210, along with other components of the transformer described below with reference to FIGS. 3 and 4.

FIG. 3 is a perspective view showing a second layer 300 of a transformer with an integrated two-way differential power divider such as the transformer 100 with an integrated two-way differential power divider of FIG. 1 in accordance with some embodiments. As shown in FIG. 3, in some embodiments, in contrast with the arrangement of the first layer 200, the first positive output terminal 106 and the first negative output terminal 108 of a transformer with an integrated two-way differential power divider are also connected to a single fourth trace 302, which is unbroken at the crossover point 206 in the second layer 300. Similarly contrasting with the arrangement of the first layer 200, the second positive output terminal 110 is connected to a fifth trace 304 and the second negative output terminal 112 is connected to a sixth trace 306; however, the fifth trace 304 and the sixth trace 306 are not directly connected at the crossover point 206 in the second layer 300. Referring back to FIG. 2, the first trace 202 is in contact with the fourth trace 302 along the length of the first trace 202. Similarly, the second trace 204 is in contact with the fourth trace 302 along the length of the second trace 204. In a similar fashion, the fifth trace 304 is in contact with the third trace 208 along the length of the fifth trace 304, and the sixth trace 306 is in contact with the third trace 208 along the length of the sixth trace 306.

Using the above-described configuration, the combination of the first trace 202, the second trace 204, and the fourth trace 302 together form a thickened trace, which forms the first secondary winding 116 of a secondary coil 308 of a transformer with an integrated two-way differential power divider. Similarly, the combination of the third trace 208, the fifth trace 304, and the sixth trace 306 together form a thickened trace, which forms the second secondary winding 118 of the secondary coil 308 of a transformer with an integrated two-way differential power divider. The thickened traces help to ensure good quality factors, e.g., low energy losses, for the transformer, while the crossing of the first and second secondary windings 116, 118 of the secondary coil 308 at the crossover point 206 provides substantial symmetry between the first and second secondary windings 116, 118, which helps to ensure a balanced output from the transformer. As shown in FIGS. 2 and 3, a shape of the first secondary winding 116 of the secondary coil 308 formed by the first trace 202, the second trace 204, and the fourth trace 302 is substantially identical to a mirrored shape of the second secondary winding 118 of the secondary coil 308 formed by the third trace 208, the fifth trace 304, and the sixth trace 306. That is, rotating either the first secondary winding 116 or the second secondary winding 118 of the secondary coil 308 about the axis of symmetry 310 of the secondary coil 308 produces a shape substantially identical to the shape of the other secondary winding.

FIG. 4 is a perspective view showing a third layer 400 of a transformer 402 with an integrated two-way differential power divider such as the transformer 100 with an integrated two-way differential power divider of FIG. 1 in accordance with some embodiments. As shown in FIG. 4, a primary coil 404 is deposited over and spaced apart from the secondary coil 308 by a dielectric medium (not shown), and the positive input terminal 102 and the negative input terminal 104 of the transformer 402 are connected to each end of the primary coil 404. As can be seen in FIGS. 3 and 4, the primary coil 404 is substantially symmetric about the axis of symmetry 310 of the secondary coil 308 and the primary coil 404 is substantially symmetric to the secondary coil 308, i.e., a shape of the primary coil 404 is substantially identical to a mirrored shape of the secondary coil 308. For example, the primary coil 404 and the secondary coil 308 have substantially the same shape and rotating the primary coil 404 about the axis of symmetry 406 of the transformer 402 produces a shape substantially identical to a shape of the secondary coil 308. The symmetry of the primary coil 404 and the secondary coil 308 helps to ensure good coupling between the primary coil 404 and the secondary coil 308.

To complete the transformer 402 with an integrated two-way differential power divider, the input capacitor 126 of FIG. 1 is connected between the positive input terminal 102 and the negative input terminal 104, an isolation network is connected between the first positive output terminal 106 and the second positive output terminal 110 including the first isolation resistor 128 in parallel with the first isolation capacitor 130, and an isolation network is connected between the first negative output terminal 108 and the second negative output terminal 112 including the second isolation resistor 132 in parallel with the second isolation capacitor 134. In some embodiments, some or all of the input capacitor 126 and the isolation networks 127 between the output terminals are located on the opposite side of the electromagnetic shield 210 from the primary coil 404 and the secondary coil 308 to provide isolation from the coils. By arranging the various traces in accordance with the layouts of FIGS. 2-4 and incorporating the input capacitor and isolation networks 127 between the output terminals, the transformer 100 with an integrated two-way differential power divider is fully realized. Notably, in some embodiments, the first isolation resistor 128 and the second isolation resistor 132 are implemented using trace resistances. However, in some embodiments, discrete resistor components implement at least a portion of the first isolation resistor 128 and the second isolation resistor 132. In some embodiments, the first and second secondary windings 116, 118 of the secondary coil 308 are not concentric with the primary coil 404, are located off-center from the primary coil 404, and/or are not symmetric with the primary coil 404 to adjust a coupling factor between the input and outputs. However, in such embodiments, the first and second secondary windings 116, 118 of the secondary coil 308 remain centered and symmetric with one another to maintain balanced outputs.

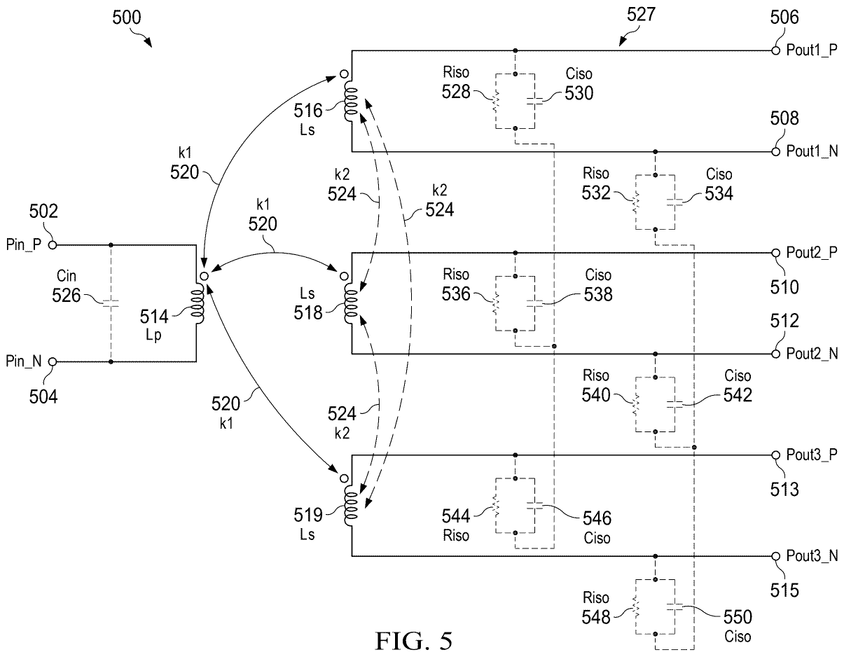

FIG. 5 is a circuit diagram of a transformer 500 with an integrated three-way differential power divider using star-connected isolation networks in accordance with some embodiments. As will be appreciated from a comparison between FIG. 1 and FIG. 5, the transformer 500 with an integrated three-way differential power divider includes many similar components to those of the transformer 100 with an integrated two-way differential power divider. For example, the transformer 500 with an integrated three-way differential power divider of FIG. 5 includes a positive input terminal 502 and a negative input terminal 504, a first positive output terminal 506 and a first negative output terminal 508, a second positive output terminal 510 and a second negative output terminal 512, and, differing from the transformer 100 of FIG. 1, additionally includes a third positive output terminal 513 and a third negative output terminal 515.

Like the transformer 100 of FIG. 1, in the example of FIG. 5, the transformer 500 includes an input capacitor 526 between the positive input terminal 502 and the negative input terminal 504 connected to a primary coil 514. Each of the output terminals of the transformer 500 is connected to a secondary winding, i.e., secondary windings 516, 518, and 519, and isolation networks 527 are provided to isolate the output terminals from one another. Notably, although star-connected isolation networks 527 are shown in FIG. 5, in some embodiments, delta-connected isolation networks are used in place of the star-connected isolation networks. A delta connection forms a closed loop with three nodes, while a star (or wye) connection has one common central point with each node connected to it. In some implementations, a star-connected isolation network has fewer interfaces with the output terminals and smaller component values, but either a delta-or star-connected can be used depending on specific implementations. In the example of the transformer 500 of FIG. 5, star-connected isolation networks 527 are provided between the respective positive and negative output terminals comprising a number of isolation resistors and isolation capacitors, i.e., isolation resistors 528, 532, 536, 540, 544, and 548 and isolation capacitors 530, 534, 538, 542, 546, and 550. As shown in FIG. 5, each of the output terminals is connected to a respective pair of an isolation resistor and an isolation capacitor connected in parallel, the positive terminals are connected through respective isolation resistors and capacitors in a star configuration, and the negative terminals are connected through respective isolation resistors and capacitors in a star configuration.

Each pair of secondary windings 516, 518, and 519 have an associated mutual inductance, e.g., mutual inductance 524, and the primary coil 514 and each of the secondary windings 516, 518, and 519 have a respective mutual inductance, e.g., mutual inductance 520. As shown in FIG. 5, the single mutual inductance 520 represents the mutual inductance between the primary coil 514 and each of the secondary windings 516, 518, and 519 and the single mutual inductance 524 represents the mutual inductance between each pair of the secondary windings 516, 518, and 519, and, in some embodiments, the mutual inductance 520 between the primary coil 514 and each of the secondary windings 516, 518, and 519 is substantially identical and the mutual inductance 524 between each respective pair of the secondary windings 516 is substantially identical. Ensuring that a substantially equal coefficient of coupling exists between the primary coil 514 and each of the secondary windings 516, 518, and 519 and/or ensuring that a substantially equal coefficient of coupling exists between each pair of the secondary windings 516, 518, and 519, helps to ensure balanced outputs from the transformer 500. However, in some embodiments, each mutual inductance may vary from each other mutual inductance between the primary coil 514 and the secondary windings 516, 518, and 519 and between the pairs of secondary windings 516, 518, and 519. The specific, actual characteristics of the resistors, capacitors, coils, and windings of the transformer 500 will vary, and thus will need to be selected in accordance with specific implementations and tolerances.

Accordingly, as shown in FIG. 5, in some embodiments, the transformer 500 with an integrated three-way differential Wilkinson power divider using star-connected isolation networks 527 is similar to the transformer 100 of FIG. 1, but also includes a third positive output terminal 513 and a third negative output terminal 515 corresponding to the third positive output terminal 513 and a third secondary winding 519 between the third positive output terminal 513 and the third negative output terminal 515. The third secondary winding 519 and the primary coil 514 have a mutual inductance 520, and the coefficient of coupling of the mutual inductance between the primary coil 514 and the third secondary winding 519 is substantially equal to the coefficient of coupling of the mutual inductance between the primary coil 514 and the first secondary winding 516. Additionally, the transformer 500 includes a star-connected isolation network connected between the first positive output terminal 506 and the third positive output terminal 513, which includes at least one capacitor in parallel with at least one resistor, e.g., isolation resistor 544 and isolation capacitor 546.

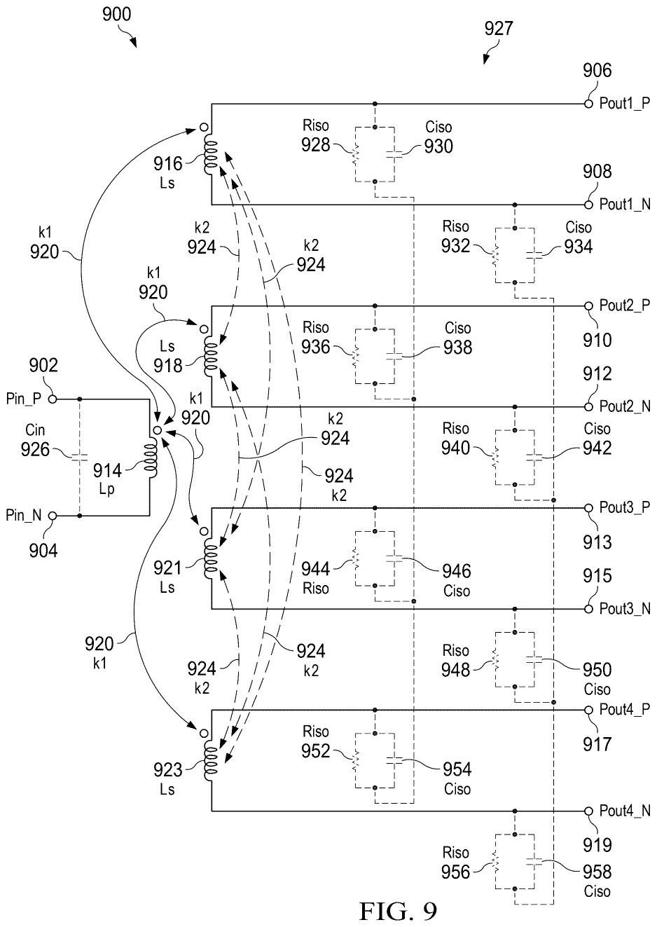

Additionally, in some embodiments, two or more of the transformer 100 of FIG. 1 and the transformer 500 of FIG. 5 are cascaded to provide non-binary splitting ratios. For example, in some embodiments, a three-way transformer is cascaded with three two-way transformers to provide a six-way transformer. Generally, two-way and three-way transformers can be cascaded to provide any required number of outputs, and those of ordinary skill in the art will understand that the transformers taught herein, such as the transformer 500 of FIG. 5, can be extended along similar lines of the expansion from the transformer 100 of FIG. 1 to the transformer 500 of FIG. 5 to a transformer with an integrated four-way differential Wilkinson power divider (see, e.g., FIGS. 9-11), a transformer with an integrated five-way differential Wilkinson power divider, and so on. Accordingly, in some embodiments, by expanding the design of the transformer 500 of FIG. 5 and/or by cascading multiple transformers, a transformer with an integrated N-way differential Wilkinson power divider can be produced having any desired number of outputs in accordance with the teachings herein.

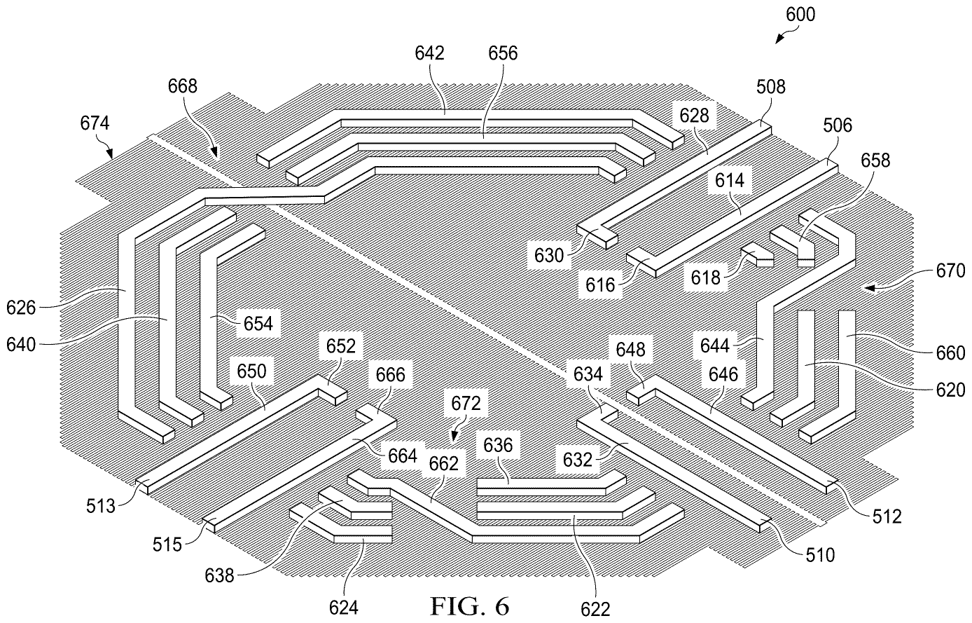

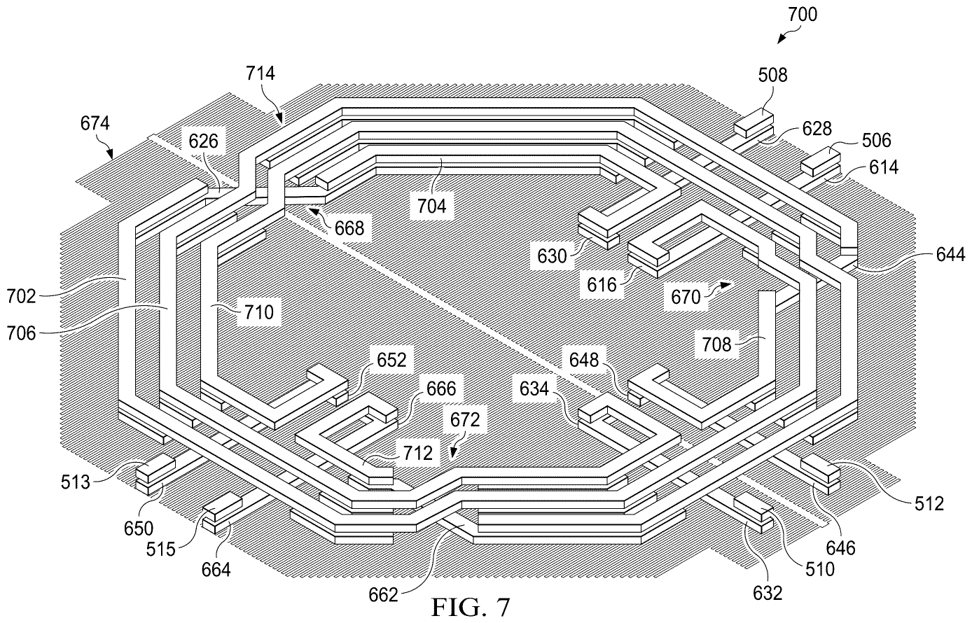

FIG. 6 is a perspective view showing a first layer 600 of a transformer with an integrated three-way differential power divider such as the transformer 500 with an integrated three-way differential power divider of FIG. 5 in accordance with some embodiments. As shown in FIG. 6, the first layer 600 of a transformer with an integrated three-way differential power divider includes positive output terminals 506, 510, and 513 and negative output terminals 508, 512, and 515. As will be discussed further in connection with FIG. 7 hereinbelow, the first positive output terminal 506 and the first negative output terminal 508 are associated with a number of traces, i.e., a trace 614 with an associated contact point 616, traces 618, 620, 622, 624, and 626, and a trace 628 with an associated contact point 630. Similarly, the second positive output terminal 510 and the second negative output terminal 512 are associated with a number of traces, i.e., a trace 632 with an associated contact point 634, traces 636, 638, 640, 642, and 644, and a trace 646 with an associated contact point 648. A third positive output terminal 513 and a third negative output terminal 515 are also associated with a number of traces, i.e., a trace 650 with an associated contact point 652, traces 654, 656, 658, 660, and 662, and a trace 664 with an associated contact point 666.

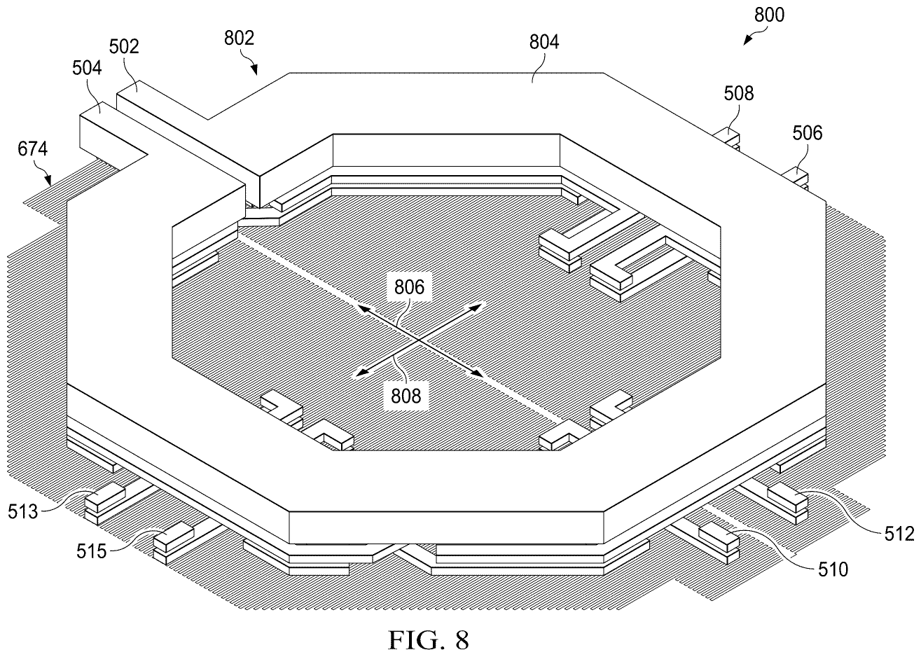

As shown in FIG. 6, the first positive output terminal 506, the second positive output terminal 510, and the third positive output terminal 513 are directly connected with the traces 614, 632, and 650, respectively. Similarly, the first negative output terminal 508, the second negative output terminal 512, and the third negative output terminal 515 are connected with the traces 628, 646, and 664, respectively. Most of the traces in FIG. 6 are segmented and not directly connected with one another, with gaps in the traces existing generally proximal to the input and output ports and three crossover points 668, 670, and 672. However, as can be seen in FIG. 6, trace 626 is continuous through crossover point 668, trace 644 is continuous through crossover point 670, and trace 662 is continuous through crossover point 672. Each of the traces are deposited over an electromagnetic shield 674, along with other components of the transformer described below with reference to FIGS. 7 and 8.

FIG. 7 is a perspective view showing a second layer 700 of a transformer with an integrated three-way differential power divider such as the transformer 500 with an integrated three-way differential power divider of FIG. 5 in accordance with some embodiments. Although only a portion of the traces of FIG. 6 are indicated in FIG. 7 for clarity, it will be appreciated that each of the components of FIG. 6 are present in the layout of FIG. 7. As shown in FIGS. 6 and 7, each of the traces of FIG. 6 are in contact with at least one interconnect trace located in the second layer 700. For example, the trace 614 is connected to an interconnect trace 702 at the associated contact point 616, the traces 618, 620, 622, and 624 are connected to the interconnect trace 702 along their respective lengths, and the trace 626 is connected to the interconnect trace 702 from a location proximal to the third positive output terminal 513 and the trace 650 to the crossover point 668. After passing through the crossover point 668, as shown in FIG. 7, the trace 626 is connected to an interconnect trace 704 from the crossover point 668 to a location proximal to the first negative output terminal 508 and the trace 628. The interconnect trace 704 then connects to the trace 628 at the associated contact point 630.

As shown in FIGS. 6 and 7, the trace 632 is connected to an interconnect trace 706 at the associated contact point 634, the traces 636, 638, 640, and 642 are connected to the interconnect trace 706 along their respective lengths, and the trace 644 is connected to the interconnect trace 706 from a location proximal to the first positive output terminal 506 and the trace 614 to the crossover point 670. After passing through the crossover point 670, as shown in FIG. 7, the trace 644 is connected to an interconnect trace 708 from the crossover point 668 to a location proximal to the second negative output terminal 512 and the trace 646. The interconnect trace 708 then connects to the trace 646 at the associated contact point 648.

As shown in FIGS. 6 and 7, the trace 650 is connected to an interconnect trace 710 at the associated contact point 652, the traces 654, 656, 658, and 660 are connected to the interconnect trace 710 along their respective lengths, and the trace 662 is connected to the interconnect trace 710 from a location proximal to the second positive output terminal 510 and the trace 632 to the crossover point 672. After passing through the crossover point 672, as shown in FIG. 7, the trace 662 is connected to an interconnect trace 712 from the crossover point 672 to a location proximal to the third negative output terminal 515 and the trace 664. The interconnect trace 712 then connects to the trace 664 at the associated contact point 666.

Using the above-described configuration, the combination of various traces of FIG. 6 in contact with various interconnect traces of FIG. 7 form thickened traces, which variously form the first secondary winding 516 between the first positive and negative output terminals 506, 508 of a secondary coil 714 of a transformer with an integrated three-way differential power divider such as the transformer 500 with an integrated three-way differential power divider of FIG. 5, the second secondary winding 518 between the second positive and negative output terminals 510, 512 of the secondary coil 714, and the third secondary winding 519 between the third positive and negative output terminals 513, 515 of the secondary coil 714. The thickened traces help to ensure good quality factors, e.g., low energy losses, for the transformer, while the crossings of the secondary windings 516, 518, and 519 of the secondary coil 714 at the crossover points 668, 670, and 672 provide substantial symmetry between the secondary windings 516, 518, and 519, which helps to ensure a balanced output from the transformer. As shown in FIG. 7, the first secondary winding 516 of the secondary coil 714 crosses the second secondary winding 518 and the third secondary winding 519 an equal number of times. For example, each of the secondary windings 516, 518, and 519 cross under the two other secondary windings at the three crossover points 668, 670, and 672 without directly contacting the other two secondary windings. Similarly, each of the secondary windings 516, 518, and 519 cross traces associated with the output ports of the two other secondary windings without directly contacting the traces associated with the output ports.

FIG. 8 is a perspective view showing a third layer 800 of a transformer 802 with an integrated three-way differential power divider such as the transformer 500 with an integrated three-way differential power divider of FIG. 5 in accordance with some embodiments. As shown in FIGS. 7 and 8, a primary coil 804 is deposited over and spaced apart from the secondary coil 714 by a dielectric medium (not shown), and the positive input terminal 502 and the negative input terminal 504 of the transformer 802 are connected to each end of the primary coil 804.

As can be seen in FIGS. 7 and 8, the primary coil 804 and the secondary coil 714 are substantially symmetric about an axis of symmetry 806 of the primary coil 804, and the primary coil 804 is substantially symmetric to the secondary coil 714, i.e., a shape of the primary coil 804 is substantially identical to a mirrored shape of the secondary coil 714. For example, the primary coil 804 and the secondary coil 714 have substantially the same shape and rotating the primary coil 804 about the axis of symmetry 808 of the transformer 802 produces a shape substantially identical to a shape of the secondary coil 714. The symmetry of the primary coil 804 and the secondary coil 714 helps to ensure good coupling between the primary coil 804 and the secondary coil 714. Additionally, as shown in FIG. 7, outputs from the secondary coil 714, such as those provided to positive and negative output terminals 506, 508, originate inside the secondary coil 714, e.g., at contact points 616 and 630 in the case of positive and negative output terminals 506, 508, which helps to minimize parasitic capacitance in the between the secondary windings 516, 518, 519 of the secondary coil 714.

To complete the transformer 802 with an integrated three-way differential power divider, the input capacitor 526 of FIG. 5 is connected between the positive input terminal 502 and the negative input terminal 504 and isolation networks 527 are connected between the positive output terminals and the negative output terminals. For example, an isolation network is provided between contact points 616, 634, and 652 of the positive output terminals 506, 510, and 513 including, e.g., the isolation resistor 528 and the isolation capacitor 530 connected in parallel, and an isolation network is provided between contact points 630, 648, and 652 of the negative output terminals 508, 512, and 515 including, e.g., the isolation resistor 532 and the isolation capacitor 534 connected in parallel. In some embodiments, some or all of the input capacitor 526 and the isolation networks 527 between the output terminals are located on the opposite side of the electromagnetic shield 674 from the primary coil 804 and the secondary coil 714 to provide isolation from the coils. By arranging the various traces in accordance with the layouts of FIGS. 6-8 and incorporating the input capacitor and isolation networks 527 between the output terminals, the transformer 802 with an integrated three-way differential power divider is fully realized. Notably, in some embodiments, the isolation resistors, such as isolation resistor 528, are implemented using trace resistances. However, in some embodiments, discrete resistor components implement at least a portion of the isolation resistors.

FIG. 9 is a circuit diagram of a transformer 900 with an integrated four-way differential power divider using star-connected isolation networks in accordance with some embodiments. As will be appreciated from a comparison between FIG. 5 and FIG. 9, the transformer 900 with an integrated four-way differential power divider includes many similar components to those of the transformer 500 with an integrated three-way differential power divider. Such as input terminals 902, 904, output terminals 906, 908, 910, 912, 913, and 915, a primary coil 914, secondary windings 916, 918, 921, and 923, a star-connected isolation network between the positive output terminals 906, 910, and 913, and a star-connected isolation network between the negative output terminals 908, 912, and 915. Similarly to the transformer 500 of FIG. 5, the isolation networks 927 of the transformer 900 include a number of isolation resistors and isolation capacitors connected in parallel, such as isolation resistors 928, 932, 936, 940, 944, and 948 and isolation capacitors 930, 934, 938, 942, 946, and 950. The primary coil 914 is coupled to the secondary windings 916, 918, 921, and 923 with mutual inductances 920, and the secondary windings 916, 918, 921, and 923 are coupled to one another with respective mutual inductances 924.

In contrast with the transformer 500 of FIG. 5, the transformer 900 additionally includes a fourth positive output terminal 917 and a fourth negative output terminal 919 corresponding to the third positive output terminal 917 and a fourth secondary winding 923 between the fourth positive output terminal 917 and the fourth negative output terminal 919. The fourth secondary winding 923 and the primary coil 914 have a mutual inductance 920, and the coefficient of coupling of the mutual inductance between the primary coil 914 and the fourth secondary winding 923 is substantially equal to the coefficient of coupling of the mutual inductance between the primary coil 914 and the other secondary windings 916, 918, and 921. Similar to the transformer 500 of FIG. 5, the transformer 900 includes a star-connected isolation network connected between each of the positive output terminals, e.g., the first positive output terminal 906 and the fourth positive output terminal 917, which includes at least one capacitor in parallel with at least one resistor, e.g., an isolation resistor 952 and an isolation capacitor 954. As shown in FIG. 9, the transformer 900 also includes a star-connected isolation network connected between each of the negative output terminals, e.g., the first negative output terminal 908 and the fourth negative output terminal 919, which includes at least one capacitor in parallel with at least one resistor, e.g., an isolation resistor 956 and an isolation capacitor 958.

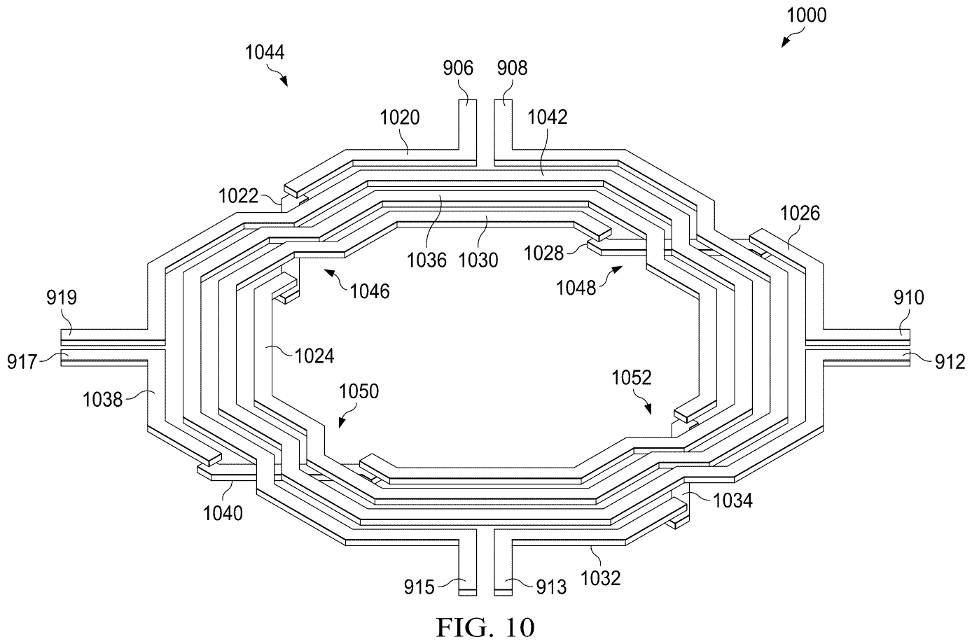

FIG. 10 is a perspective view showing first and second layers 1000 of a transformer with an integrated four-way differential power divider such as the transformer 900 with an integrated four-way differential power divider of FIG. 9 in accordance with some embodiments. As shown in FIG. 10, the first positive output terminal 906 is connected to an upper trace 1020, which connects to a lower trace 1022, which then connects back up to an upper trace 1024, which connects to the first negative output terminal 908, forming the first secondary winding 916. Similarly, the second positive output terminal 910 is connected to an upper trace 1026, which connects to a lower trace 1028, which then connects back up to an upper trace 1030, which connects to the second negative output terminal 912, forming the second secondary winding 918. The third positive output terminal 913 is connected to an upper trace 1032, which connects to a lower trace 1034, which then connects back up to an upper trace 1036, which connects to the third negative output terminal 915, forming the third secondary winding 921. The fourth positive output terminal 917 is connected to an upper trace 1038, which connects to a lower trace 1040, which then connects back up to an upper trace 1042, which connects to the fourth negative output terminal 919, forming the fourth secondary winding 923. Together, the secondary windings 916, 918, 921, and 923 form a secondary coil 1044 of a transformer with an integrated four-way differential power divider.

As shown in FIG. 10, each of the secondary windings crosses each of the other secondary windings an equal number of times, which helps to ensure balanced outputs for the transformer. For example, the first secondary winding 916 crosses the second, third, and fourth secondary windings 918, 921, and 923 at crossover point 1046. Similarly, the second, third, and fourth secondary windings 918, 921, and 923 cross the respective other secondary windings at crossover points 1048, 1052, and 1050.

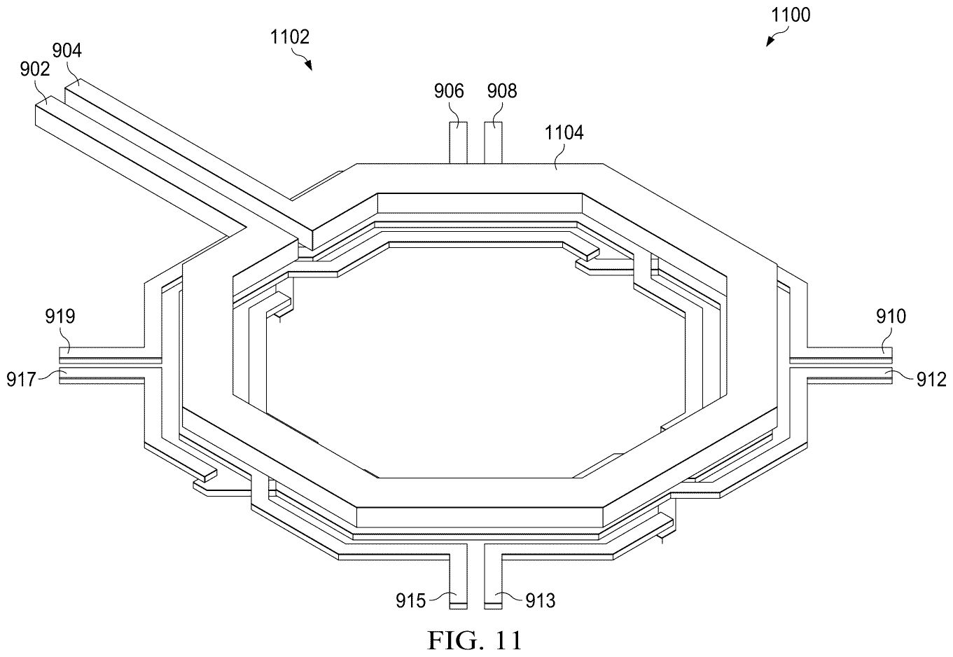

FIG. 11 is a perspective view showing a third layer 1100 of a transformer 1102 with an integrated four-way differential power divider in accordance with some embodiments. As shown in FIGS. 10 and 11, a primary coil 1104 is deposited over the secondary coil 1044 and spaced apart from the secondary coil 1044 by a dielectric medium (not shown), and the positive input terminal 902 and the negative input terminal 904 of the transformer 1102 are connected to each end of the primary coil 1104. Similar to the transformer 802 of FIG. 8, to complete the transformer 1102, as shown in FIG. 9, the input capacitor 926 is connected between the input terminals 902, 904, an isolation network is connected between the positive output terminals 906, 910, 913, and 917, and an isolation network is connected between the negative output terminals 908, 912, 915, and 919. Although not shown in FIG. 11, as with the transformers 402 and 802 of FIGS. 4 and 8, the traces of the transformer 1102 may be deposited over an electromagnetic shield and portions of the isolation network may be located on the opposite side of the electromagnetic shield from the traces of the transformer 1102.

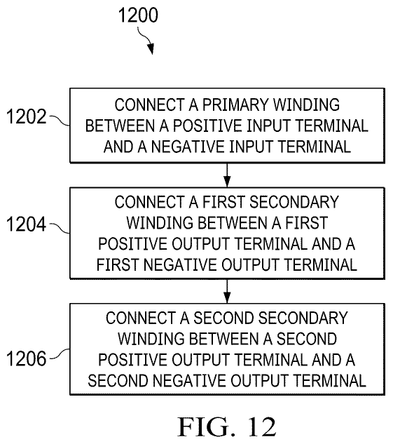

FIG. 12 is a flow diagram of a method 1200 of assembling a transformer with an integrated differential Wilkinson power divider, such as one of the transformers 100, 402, 500, 802, 900, and 1102 of FIGS. 1, 4, 5, 8, 9, and 11, in accordance with some embodiments. At block 1202, a primary coil, such as one of the primary coils 114, 404, 514, 804, 914, and 1104 of FIGS. 1, 4, 5, 8, 9, and 11, is connected between a positive input terminal and a negative input terminal. At block 1204, a first secondary winding, such as one of the first secondary windings 116, 516, and 916 of FIGS. 1, 5, and 9, is connected between a first positive output terminal and a first negative output terminal. At block 1206, a second secondary winding, such as one of the second secondary windings 118, 518, and 918 of FIGS. 1, 5, and 9, is connected between a second positive output terminal and a second negative output terminal. In some embodiments, the first secondary winding and the primary coil are configured with a first mutual inductance, the second secondary winding and the primary coil are configured with a second mutual inductance, and a coefficient of coupling of the first mutual inductance is configured to be substantially equal to a coefficient of coupling of the second mutual inductance.

In some embodiments, the method 1200 includes connecting a first isolation network between the first positive output terminal and the second positive output terminal. In some embodiments, the first isolation network includes a capacitor in parallel with a resistor. In some embodiments, the method 1200 includes connecting a second isolation network between the first negative output terminal and the second negative output terminal. In some embodiments, the method 1200 includes connecting a third secondary winding between a third positive output terminal and a third negative output terminal, where the third secondary winding and the primary coil have a third mutual inductance, and the coefficient of coupling of the first mutual inductance is substantially equal to a coefficient of coupling of the third mutual inductance.

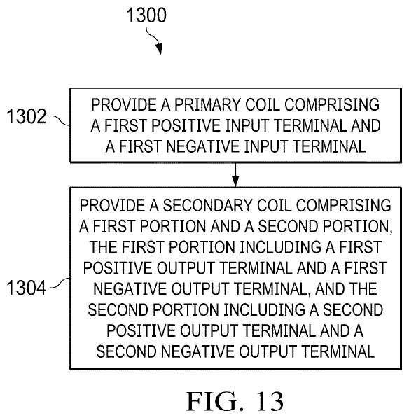

FIG. 13 is a flow diagram of a method 1300 of arranging traces in a transformer with an integrated differential power divider, such as one of the transformers 100, 402, 500, 802, 900, 1102 of FIGS. 1, 4, 5, 8, 9, and 11, in accordance with some embodiments. At block 1302, a primary coil comprising a first positive input terminal and a first negative input terminal is provided, such as one of the primary coils 114, 404, 514, 804, 914, and 1104 of FIGS. 1, 4, 5, 8, 9, and 11. At block 1304, a secondary coil comprising a first secondary winding and a second secondary winding is provided, the first secondary winding including a first positive output terminal and a first negative output terminal, and the second secondary winding including a second positive output terminal and a second negative output terminal, such as one of the secondary coils 308, 714, and 1044 of FIGS. 3, 7, and 10 with one of the first secondary windings 116, 516, and 916 of FIGS. 1, 5, and 9 and one of the second secondary windings 118, 518, and 918 of FIGS. 1, 5, and 9. In some embodiments, the primary coil and the secondary coil are configured to be substantially symmetric, and the first secondary winding and the second secondary winding of the secondary coil are configured to be substantially symmetric.

In some embodiments, certain aspects of the techniques described above, such as the methods 1200, 1300, may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1-15. (canceled)

16. A differential Wilkinson power divider, comprising:
a primary coil between a positive input terminal and a negative input terminal;
a first secondary winding between a first positive output terminal and a first negative output terminal; and
a second secondary winding between a second positive output terminal and a second negative output terminal,
wherein the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance.

17. The differential Wilkinson power divider of claim 16, further comprising a first isolation network connected between the first positive output terminal and the second positive output terminal.

18. The differential Wilkinson power divider of claim 17, wherein the first isolation network includes a capacitor in parallel with a resistor.

19. The differential Wilkinson power divider of claim 17, further comprising a second isolation network connected between the first negative output terminal and the second negative output terminal.

20. The differential Wilkinson power divider of claim 19, wherein the second isolation network includes a capacitor in parallel with a resistor.

21. The differential Wilkinson power divider of claim 16, further comprising:
a third positive output terminal and a third negative output terminal corresponding to the third positive output terminal; and
a third secondary winding between the third positive output terminal and the third negative output terminal,
wherein the third secondary winding and the primary coil have a third mutual inductance, and the coefficient of coupling of the first mutual inductance is substantially equal to a coefficient of coupling of the third mutual inductance.

22. The differential Wilkinson power divider of claim 21, further comprising an isolation network connected between the first positive output terminal and the third positive output terminal.

23. The differential Wilkinson power divider of claim 22, wherein the isolation network includes a capacitor in parallel with a resistor.

24. The differential Wilkinson power divider of claim 21, further comprising:
a fourth positive output terminal and a fourth negative output terminal corresponding to the fourth positive output terminal; and
a fourth secondary winding between the fourth positive output terminal and the fourth negative output terminal,
wherein the fourth secondary winding and the primary coil have a fourth mutual inductance, and the coefficient of coupling of the first mutual inductance is substantially equal to a coefficient of coupling of the fourth mutual inductance.

25. The differential Wilkinson power divider of claim 24, further comprising an isolation network connected between the first positive output terminal and the fourth positive output terminal.

26. A differential Wilkinson power divider, comprising:
a primary coil comprising a first positive input terminal and a first negative input terminal; and
a secondary coil comprising a first secondary winding and a second secondary winding, the first secondary winding including a first positive output terminal and a first negative output terminal, and the second secondary winding including a second positive output terminal and a second negative output terminal,
wherein the primary coil and the secondary coil are substantially symmetric, and the first secondary winding and the second secondary winding of the secondary coil are substantially symmetric.

27. The differential Wilkinson power divider of claim 26, wherein a shape of the first secondary winding of the secondary coil is substantially identical to a mirrored shape of the second secondary winding of the secondary coil.

28. The differential Wilkinson power divider of claim 26, wherein the first secondary winding of the secondary coil crosses the second secondary winding of the secondary coil.

29. The differential Wilkinson power divider of claim 28, wherein the secondary coil further comprises a third secondary winding including a third positive output terminal and a third negative output terminal, and wherein the first secondary winding of the secondary coil crosses the second secondary winding and the third secondary winding an equal number of times.

30. The differential Wilkinson power divider of claim 29, wherein the secondary coil further comprises a fourth secondary winding including a fourth positive output terminal and a fourth negative output terminal, and wherein the first secondary winding of the secondary coil crosses the second secondary winding, the third secondary winding, and the fourth secondary winding an equal number of times.

31. The differential Wilkinson power divider of claim 26, wherein the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance.

32. A differential Wilkinson power divider, comprising:
a primary coil between a positive input terminal and a negative input terminal; and
a secondary coil comprising a first secondary winding and a second secondary winding, the first secondary winding including a first positive output terminal and a first negative output terminal, and the second secondary winding including a second positive output terminal and a second negative output terminal,
wherein the first secondary winding and the primary coil have a first mutual inductance, the second secondary winding and the primary coil have a second mutual inductance, and a coefficient of coupling of the first mutual inductance is substantially equal to a coefficient of coupling of the second mutual inductance, and
wherein the primary coil and the secondary coil are substantially symmetric, and the first secondary winding and the second secondary winding of the secondary coil are substantially symmetric.

33. The differential Wilkinson power divider of claim 32, further comprising a first isolation network connected between the first positive output terminal and the second positive output terminal.

34. The differential Wilkinson power divider of claim 32, wherein a shape of the first secondary winding of the secondary coil is substantially identical to a mirrored shape of the second secondary winding of the secondary coil.

35. The differential Wilkinson power divider of claim 32, wherein the first secondary winding of the secondary coil crosses the second secondary winding of the secondary coil.
